(19) United States
(12) Patent Application Publication
(10) Pub. No.: US 2026/0347124 A1
(43) Pub. Date: Nov. 5, 2026

(54) CHUTE APPARATUSES FOR GUIDING WOOD STRANDS, AND ASSOCIATED SYSTEMS AND METHODS

(71) Applicant: Weyerhaeuser NR Company, Seattle, WA (US)

(72) Inventors: Anton David Pugel, Boise, ID (US); Norbert Kott, Langley (CA); Patrick Joseph Zabloski, Kenora (CA)

(21) Appl. No.: 19/663,653

(22) Filed: Apr. 30, 2026

Related U.S. Application Data
(60) Provisional application No. 63/797,330, filed on Apr. 30, 2025.

(51) Int. Cl. B65G 47/20

(52) U.S. Cl. CPC B65G 47/20

(57) ABSTRACT

Apparatuses, systems, and methods for guiding wood strands exiting a wood strander are disclosed. An apparatus comprises a strander assembly, a curved chute coupled to the strander assembly, and a conveyor. The strander assembly includes a strander inlet configured to receive wood strands from logs, and a strander outlet. The curved chute is coupled to the strander outlet via a chute inlet such that the chute receives the wood strands discharged from the strander outlet in a first direction. The curved chute includes a chute outlet configured to discharge the wood strands in a second direction different from the first direction. A curved section of the chute connects the chute inlet to the chute outlet. The conveyor is positioned at the outlet of the chute and is configured to transport the wood strands away from the chute.

### CROSS-REFERENCE TO RELATED APPLICATION

This application claims the benefit of U.S. Provisional Patent Application No. 63/797,330, filed Apr. 30, 2025, and titled “CHUTE APPARATUSES FOR GUIDING WOOD STRANDS, AND ASSOCIATED SYSTEMS AND METHODS,” which is incorporated herein by reference in its entirety.

### TECHNICAL FIELD

The present disclosure is generally related to apparatuses, systems, and methods for guiding wood strands during wood stranding operations.

### BACKGROUND

Strand lumber is a type of engineered wood product made from wood strands that are combined with resin, wax, and/or other additives. Generally, strand lumber is strong, stiff, durable, dimensionally stable, and ecologically friendly, making it popular for a wide variety of structural purposes, such as headers, beams, floor panels, millwork, rim board, tall wall studs, sill plates, window framing, and the like.

The quality of strand lumber depends in large part on the integrity of the wood strands forming the strand lumber. For example, in some applications, a relatively uniform geometry and size of wood strands produces high-quality (e.g., high-strength/stiffness) strand lumber. However, some conventional systems and methods of producing wood strands risk damaging the strands and/or producing geometrically non-uniform strands, which can reduce the quality and/or integrity of the resultant strand lumber.

### BRIEF DESCRIPTION OF THE DRAWINGS

FIG. 1A is a perspective view of a system for guiding wood strands, in accordance with embodiments of the present technology.

FIG. 1B is a side view of a system for guiding wood strands, in accordance with embodiments of the present technology.

FIG. 2 is a perspective view of a chute, in accordance with embodiments of the present technology.

FIG. 3 is a partially schematic side view of a system, in accordance with embodiments of the present technology.

FIG. 4 is a flowchart illustrating a method of guiding wood strands, in accordance with embodiments of the present technology.

The drawings have not necessarily been drawn to scale. Similarly, some components and/or operations may be separated into different blocks or combined into a single block for the purposes of discussion of some of the embodiments of the disclosed system. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents and alternatives falling within the scope of the technology as defined by the appended claims.

### DETAILED DESCRIPTION

The disclosed technology provides apparatuses, systems, and methods for guiding wood strands exiting a wood strander. For example, the present technology includes apparatuses for slowing the descent of wood strands exiting a wood strander before being received by a conveyor belt. The quality (e.g., strength/stiffness) of strand lumber, such as laminated strand lumber (LSL), oriented strand board (OSB), and the like, depends at least in part on the integrity of the wood strands used for the strand lumber. Generally, wood strands are produced by providing logs to a wood strander (also referred to as a strander assembly), which can include a cutting area or chamber with multiple blades or knives (e.g., mounted on a rotating disc) configured to cut the logs into wood strands of a desired geometry and size. In some applications, as the logs are cut, the resultant wood strands exit the wood strander at a high velocity (e.g., approximately 40 meters per second), where they are received by a conveyor belt configured to transport the wood strands for further processing. During this process, many wood strands are damaged as they collide with each other and with components of the strander outfeed (e.g., the conveyor belt) at high velocity. This can reduce the quality and integrity of the resultant strand lumber in which the wood strands are incorporated. It can also result in damage and/or excessive wear of strander components and/or outfeed components (e.g., the conveyor belt).

Additionally, many conventional systems fail to adequately distribute and/or disperse the wood strands evenly across the conveyor belt. This can result in the accumulation of wood strands into piles on the conveyor belt, which can reduce the effectiveness of subsequent processing and may even damage processing equipment. For example, piles of wood strands can make it difficult to screen (i.e., remove) dimensionally unacceptable wood strands from acceptable wood strands because the unacceptable wood strands are “knit” together and/or buried within a pile of otherwise acceptable wood strands. In other words, this creates an interlocking effect between the acceptable wood strands and the unacceptable strands, making it difficult to separate them. The high speed with which the wood strands collide with each other can exacerbate this problem by creating extremely dense piles that can damage processing equipment.

The disclosed technology addresses these and other issues by providing an apparatus comprising a strander assembly, a curved chute coupled to the strander assembly, and a conveyor. The strander assembly includes a strander inlet configured to receive wood strands from logs, and a strander outlet. The curved chute is coupled to the strander outlet via a chute inlet such that the chute receives the wood strands discharged from the strander outlet in a first direction (e.g., at least approximately parallel to a direction of gravity). The curved chute includes a chute outlet configured to discharge the wood strands in a second direction different from the first direction (e.g., at least approximately perpendicular to the first direction). A curved section of the chute connects the chute inlet to the chute outlet. The conveyor is positioned at the outlet of the chute and is configured to transport the wood strands away from the chute. In some embodiments, the chute inlet has a first angle relative to the conveyor and the chute outlet has a second angle relative to the conveyor that is different from the first angle. Additionally or alternatively, the chute inlet has a first width and the chute outlet has a second width greater than the first width. In some embodiments, the chute includes one or more structures (e.g., grooves, baffles, diverters) configured to disperse the wood strands throughout the chute and/or conveyor.

Embodiments of the present disclosure can enable the chute to absorb, reduce, and/or disburse the force of the wood strands exiting the strander assembly, such that damage due to collision with other wood strands and/or components of the system is reduced or mitigated. For example, the chute can slow the descent of the wood strands exiting the strander assembly by guiding the wood strands along the curved section of the chute. The chute can also spread the incident wood strands throughout the chute via, for example, a combination of the impetus of the incident wood strands and the use of diverters, grooves, baffles, ridges, and other structures internal to the chute. By spreading the wood strands throughout the chute, the wood strands are less likely to concentrate into piles on the conveyor belt as they are discharged from the chute. In some aspects of the present technology, this can inhibit the wood strands from “knitting” together and/or untangle the knit together wood strands, inhibiting damage to the dimensional integrity of the wood strands.

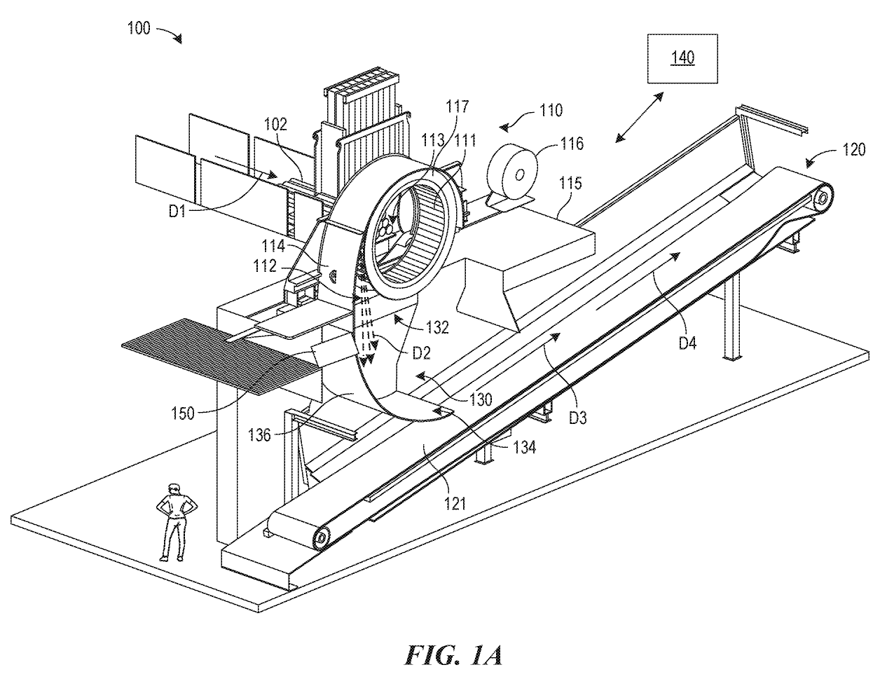

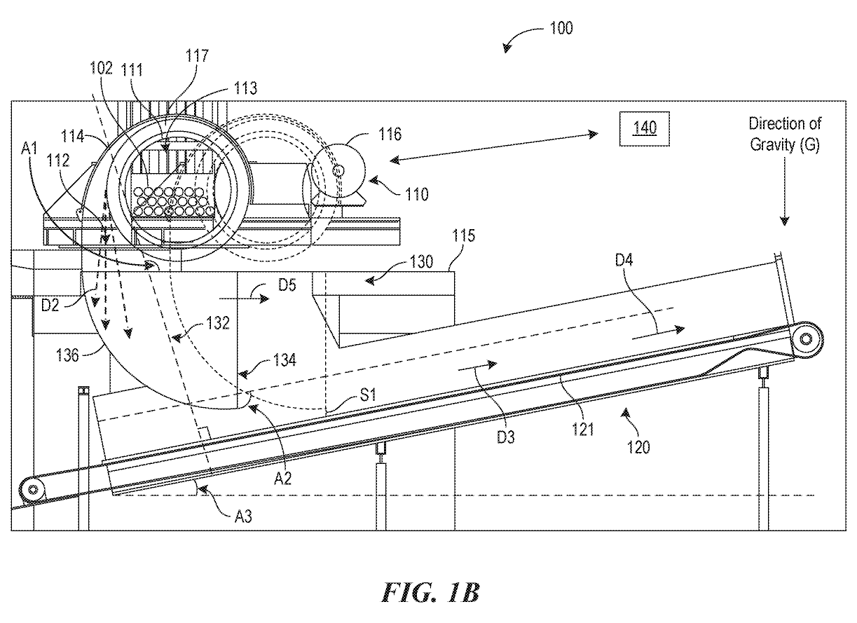

FIGS. 1A and 1B are perspective views of a system 100 for guiding wood strands, in accordance with embodiments of the present technology. Referring to FIGS. 1A and 1B together, in the present embodiments, the system 100 comprises a strander assembly 110, a chute 130 configured to be coupled to the strander assembly 110, a conveyor 120, and a controller 140.

The strander assembly 110 is configured to receive an input material 102, such as logs, and to output strands of input material 102, such as strands of wood (i.e., “wood strands”). The input material 102 travels along and/or is fed via an input path D1 to a cutting area 113 (also referred to as a cutting chamber). The cutting area 113 includes one or more blades 111 (also referred to as knives) configured to cut the input material 102 such that strands of a particular width, length, thickness, size, geometry, and/or other parameters are produced from the input material 102. In some embodiments, the blades 111 are configured to rotate in a circular pathway to cut the input material 102 in the cutting area 113. For example, the blades 111 of the strander assembly 110 can be mounted on a rotating disc 117 (shown in FIGS. 1A and 1B). Once the input material 102 is fed into the cutting area 113, the rotating disc 117 can rapidly rotate the blades 111 while moving in a direction D5 that facilitates contact between the blades 111 and the input material 102. For example, as shown in FIG. 1B, the rotating disc 117 can move in the direction D5 (shown in FIG. 1B) at least approximately perpendicular to the input material 102 and/or input path D1 (shown in FIG. 1A), bringing the blades 111 into contact with the input material 102. In some embodiments, movement of the blades 111 and/or rotating disc 117 is driven by a drive mechanism 116, such as an electric motor.

In some embodiments, the blades 111 are configured to cut the strands from the input material 102 such that the strands exit the strander assembly 110 via a strander outlet 112. In some embodiments, the strands generally proceed along one or more output paths D2 through the strander outlet 112, and in a downward direction (relative to a direction of gravity).

In some embodiments, the strander assembly 110 includes one or more shielding components 114 configured to deflect and/or direct the strands along one or more of the output paths D2, and to prevent strands from escaping the strander assembly 110 area in an uncontrolled manner. In some embodiments, the one or more shielding components 114 are coupled to the rotating disc 117 and/or a support platform 115. In some embodiments, the shielding components 114 are configured to move with the rotating disc 117 and/or the blades 111 (e.g., when the input material 102 is being cut).

The strands exiting the strander assembly 110 are received by the chute 130. The chute 130 includes a chute inlet 132 configured to receive the strands exiting the strander assembly 110, a chute outlet 134 configured to discharge the strands from the chute 130, and a curved section 136 extending between the chute inlet 132 and chute outlet 134. The strander assembly 110 can further include a support platform 115, a shielding component 114, and/or a rotating disc 117, each of which can be coupled to the chute 130. For example, a portion of the chute inlet 132 can be configured to be welded and/or bolted to a portion of the shielding component 114. In some embodiments, the strands exiting the strander assembly 110 can be uninhibited by components other than the chute 130. For example, the pathway from the chute 130 may not include a bulkhead, plate, or other components to inhibit movement of the strands. In some embodiments, the chute 130 can coupled to the moveable components of the strander assembly 110, such as the rotating disc 117 and/or shielding components 114. In such embodiments, the chute 130 can move such that the chute 130 and chute inlet 132 maintain a position relative to output paths D2 (discussed further herein), cutting area 113, and/or rotating disc 117 as the input material 102 is cut. In some embodiments, the chute 130 can be retrofitted to couple to an existing strander assembly 110 with additional or other components.

In some embodiments, the chute inlet 132 is configured to receive the strands exiting the strander assembly 110 in a first direction. For example, the chute inlet 132 can receive the strands exiting the strander assembly along the one or more of the output paths D2, which can be in a generally downward direction with respect to a direction of gravity (e.g., at least approximately parallel to the direction of gravity). In some embodiments, the chute inlet 132 is configured to receive strands exiting the strander assembly in directions other than along the output paths D2. In some embodiments, the chute inlet 132 is angled relative to the conveyor 120. For example, the chute inlet 132 can be angled at a first angle A1 relative to the conveyor 120, where the first angle A1 is angled at least approximately 80 degrees, 90 degrees, 100 degrees, or 110 degrees relative to the conveyor 120, or within a range of approximately 80–110 degrees or any increment therebetween (e.g., 93 degrees) relative to the conveyor 120. In some embodiments, the first angle A1 is at least approximately perpendicular to the conveyor 120.

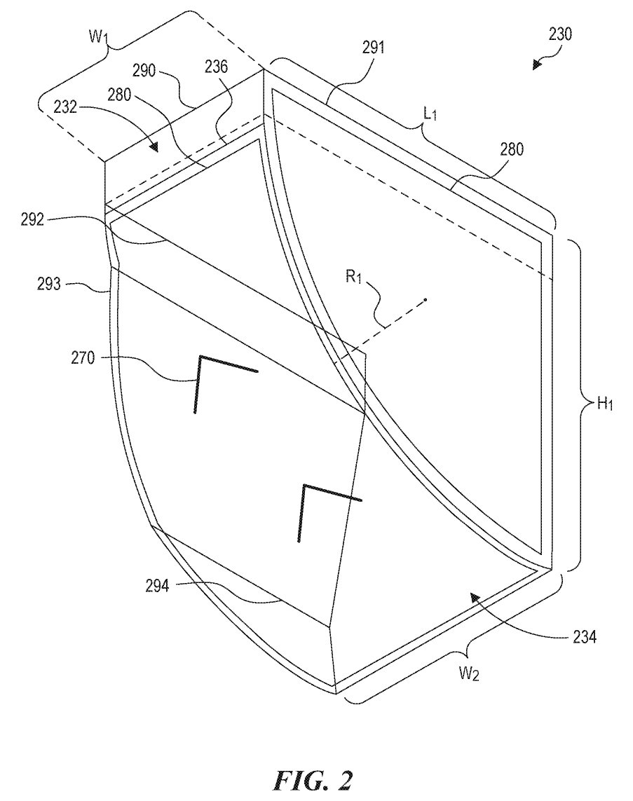

The curved section 136 is configured to guide strands received by the chute inlet 132 to the chute outlet 134. For example, the curved section 136 can guide the strands from a first direction, such as an output path D2 of the strands when received by the chute inlet 132, to a second direction that is at least approximately perpendicular to the first direction, such as a discharge direction D3 of the chute outlet 134. In some embodiments, the curved section 136 is configured to slow the descent of the strands as the strands proceed through the chute 130. For example, the curved section 136 can be curved such that at least a portion of the force of each of the strands entering the chute 130 (e.g., via the chute inlet 132) is dispersed (e.g., via friction, gravity, air resistance) as the strands proceed through the chute 130. In some embodiments, the curved section 136 includes one or more structures (not pictured, discussed further with reference to FIG. 2) configured to reduce the velocity and/or force of the strands, as well as distribute the strands throughout the chute 130. In some embodiments, the curved section 136 is formed of a continuous curve of an approximately constant radius from the chute inlet 132 to the chute outlet 134, or of a non-continuous curve with individual straight sections.

The chute outlet 134 is configured to discharge strands in a discharge direction D3. In some embodiments, the discharge direction D3 is different (e.g., at least approximately perpendicular) compared to the direction of the strands when received by the chute inlet 132. In some embodiments, the discharge direction D3 is at least approximately perpendicular to a direction of gravity. In some embodiments, the chute outlet 134 can be configured to direct strands in a discharge direction D3 that is approximately the same (e.g., parallel) compared to a transport direction D4 of the conveyor 120. In some embodiments, the chute outlet 134 is angled relative to the conveyor 120. For example, the chute outlet 134 can have a second angle A2 that is approximately 0–10 degrees offset relative to the conveyor 120. In some embodiments, the second angle A2 is at least approximately parallel to the conveyor 120. In some embodiments, the chute inlet 132, the curved section 136, and/or the chute outlet 134 can be composed of a single continuous piece, or the chute inlet 132, the curved section 136, and/or the chute outlet 134 can each be composed of multiple pieces coupled (e.g., adhered, welded, fixed) together.

The conveyor 120 is configured to transport strands of input material 102 away from the chute 130 and strander assembly 110 and onto further processing. In some embodiments, the conveyor 120 includes a conveyor belt 121 configured to move in a transport direction D4. In some embodiments, the transport direction D4 is at least approximately the same as the discharge direction D3 of the chute outlet 134. In some embodiments, the conveyor 120 is inclined at an angle A3 with reference to a direction of gravity. In some embodiments, the chute 130 is configured to maintain a minimum stand-off distance S1 from the conveyor 120 and/or the conveyor belt 121, and/or the chute 130 is configured to maintain a distance greater than the stand-off distance S1 from the conveyor 120 and/or conveyor belt 121. In some embodiments, the chute 130 is configured to maintain an at least approximately constant stand-off distance S1 from the conveyor 120 and/or conveyor belt 121 (e.g., as the chute 130 moves in the direction D5). In some embodiments, the stand-off distance S1 is at least approximately 6 inches, 7 inches, 8 inches, 9 inches, 10 inches, 11 inches, or 12 inches between the chute 130 and the conveyor 120 and/or conveyor belt 121, or within a range of approximately 6–12 inches or any increment therebetween (e.g., 10.75 inches) between the chute 130 and the conveyor 120 and/or conveyor belt 121. Generally, the standoff distance S1 is adjusted based on the angle between the conveyor 120 and the curved section 136 to reduce damage to the strands.

In some embodiments, the system 100 includes a controller 140 configured to control one or more functions and/or parameters of the system 100. For example, the controller can be operably coupled to the strander assembly 110, conveyor 120, and/or chute 130, and/or configured to control one or more parameters of the strander assembly 110, conveyor 120, and/or chute 130. In some embodiments, the controller 140 is configured to control one or more of: cut speed of the strander assembly 110, rotation speed of the rotating disc 117, feed rate of the input material 102 into the cutting area 113, movement of the strander assembly 110, movement of the chute 130, operation of the drive mechanism 116, transport direction D4 of the conveyor 120, and speed of the conveyor 120 and/or conveyor belt 121.

In some embodiments, the controller 140 includes one or more hardware and software components for controlling operation of the system 100. For example, the controller 140 can include one or more processors (e.g., central processing unit(s) (CPU(s)), graphics processing unit(s) (GPU(s)), holographic processing unit(s) (HPU(s)), etc.) and memory (e.g., volatile storage, non-volatile storage) for storing instructions to be executed by the one or more processors. The controller 140 can include or be in the form of one or more controllers, one or more controller circuits, or the like, or a combination thereof. Examples of controllers can include a microcontroller, a programmable logic controller (PLC), a digital signal controller (DSC), a motor controller, or the like, or a combination thereof. In some embodiments, the controller 140 can include a control circuit formed by a plurality of controllers.

In some embodiments, the system 100 includes a pump (e.g., a jet pump) 150 configured to apply a force to strands in the chute 130 via discharge from the pump 150. For example, during a cleaning operation following a cutting operation, the pump 150 can spray and/or discharge a fluid stream (e.g., air stream) into the chute 130 to dislodge strands (e.g., assist with strand movement in the chute 130), clean the chute 130, and/or prepare the chute 130 for replacement operations (e.g., replacing parts of the chute, chute replacement). In some embodiments, the pump 150 can be used continuously to allow the wood strands to be transported via an air conveying system in addition to or in lieu of the conveyor belt 121 and/or the chute 130. For example, strands exiting the strander assembly 110 can fall toward the air conveying system (e.g., not in contact with the chute 130), and an air pump of the air conveying system can direct the strands in a desired direction. In some embodiments, this can include directing the strands to the conveyor belt 121, and, in other embodiments, this can include directing the strands to a desired location.

FIG. 2 is a perspective view of a chute 230, in accordance with embodiments of the present technology. In some embodiments, chute 230 includes one or more features and components generally similar/identical to the features and components of chute 130 of FIGS. 1A and 1B. Moreover, all or some of the features and functionality of the chute 230 can be incorporated into the system 100 described with references to FIGS. 1A and 1B.

The chute 230 is configured to guide strands of input material from a first direction (e.g., one or more output paths D2 of FIGS. 1A and 1B) to a second direction (e.g., discharge direction D3) as the strands descend. In the present embodiments, chute 230 includes a chute inlet 232 configured to receive strands of input material (e.g., from a strander assembly). In some embodiments, the chute inlet 232 is configured to receive the strands from a first direction (e.g., a discharge direction of a strander assembly and/or a discharge direction of a cutting area/blades of a cutting mechanism). In some embodiments, the chute inlet 232 can have an inlet width W₁ at least approximately the same as the width W₂ of an outlet of a strander assembly. In some embodiments, the inlet width W₁ is different from (e.g., greater than) the width W₂ of an outlet of a strander assembly, in order to accommodate (e.g., receive) strands exiting the strander assembly at a wide variety of trajectories.

The chute 230 can include a first upper surface 290 (e.g., corresponding to a minor side of the chute inlet 232), a second upper surface 291 (e.g., corresponding to a major side of the chute inlet 232 that is opposite a strander assembly), and/or a third upper surface 292 (e.g., corresponding to a major side of the chute inlet 232 that is on the same side as a strander assembly). The first, second, and third upper surfaces 290, 291, 292 can couple the chute inlet 232 to the stander assembly. For example, the first, second, and third upper surfaces 290, 291, 292 can be configured to couple to a lower area of a shielding component (e.g., shielding component 114 of FIGS. 1A–1B) and/or rotating disc of a strander assembly. Coupling the chute 230 and/or chute inlet 232 to the shielding component and/or rotating disc of the strander assembly can facilitate movement of the chute 230 with the lateral movement of the rotating disc (e.g., movement direction D5 of FIG. 1B). In some embodiments, one or more of the first, second, and third upper surfaces 290, 291, 292 are coupled to fixed (i.e., non-moving) components of the strander assembly, such as a support platform (e.g., support platform 115 of FIGS. 1A–1B) of the strander assembly. In such embodiments, the chute 230 may remain stationary as the rotating disc moves laterally.

In some embodiments, the second upper surface 291 and/or third upper surface 292 (e.g., corresponding to the major sides of the chute 230) can have a first width, and a lower section 294 (opposite an upper section 293) of the chute 230 can have a second width greater than the first width. In some embodiments, the first width is at least approximately the same the width W₁ of the chute inlet 232, and the second width is at least approximately the same as the width W₂ of the chute outlet 234. This allows strands received by the chute inlet 232 at a relatively narrow width (i.e., the first width and/or inlet width W₁) to disperse or spread over a greater area as they are guided down a curved section 236 of the chute, allowing for a greater reduction in force and/or speed of the strands before being discharged from a chute outlet 234. The expanding width from the first width to the second width also mitigates the buildup of piles of strands on, for example, a conveyor positioned at the chute outlet 234 because the strands have more room to spread out and are less likely to become concentrated prior to discharge from the chute 230. In some embodiments, the first width and/or inlet width W₁ is at least approximately 50 inches, 55 inches, 60 inches, 65 inches, 70 inches, 75 inches, or 80 inches, or within a range of approximately 50–80 inches or any increment therebetween (e.g., 69.5 inches). In some embodiments, the second width and/or outlet width W₂ is at least approximately 70 inches, 75 inches, 80 inches, 85 inches, 90 inches, 95 inches, 100 inches, 105 inches, 110 inches, 115 inches, 120 inches, or within a range of approximately 70–120 inches or any increment therebetween (e.g., 94.25 inches).

Chute 230 includes a curved section 236 connecting the chute inlet 232 to a chute outlet 234. In some embodiments, the curved section 236 forms a continuous curve between the chute inlet 232 and the chute outlet 234 of a radius R₁. In some embodiments, the continuous curve is formed of a constant radius R₁ from the chute inlet 232 to the chute outlet 234. In some embodiments, the curved section 236 is formed of one or more sections of varying radius relative to a center point of the chute 230. In some embodiments, the curved section 236 includes one or more straight and/or flat sections. As one skilled in the art will appreciate, a greater radius R₁ is likely to result in a greater distance for strands in the chute 230 to travel prior to discharge.

In some embodiments, the curved section 236 includes one or more structures 270 configured to disperse and/or spread strands throughout a portion of the chute 230. For example, the structures 270 can include one or more of: grooves, ridges, baffles, diverters, deflectors, bumpers, and/or bumps. The structures 270 can mitigate and or prevent the formation of piles or clumps of strands on, for example, a surface of a conveyor as the strands are discharged from the chute outlet 234. As the strands collide and/or interact with the structures 270, the strands can become dispersed throughout the curved section 236 and chute 230 prior to being discharged. In some embodiments, the one or more structures 270 are positioned on the other interior surfaces of the chute 230. In some embodiments, the chute 230 and/or curved section 236 can be constructed of steel of suitable grades and/or similar materials such as titanium to reduce wear on the chute 230 and/or the curved section 236 over time.

In some embodiments, the chute 230 and/or curved section 236 have a height (H₁) and a length (L₁). As one skilled in the art will recognize, the greater the height H₁ and the length L₁ of the chute 230 and/or curved section 236, the greater the distance the strands must travel prior to discharge from the chute outlet 234, which increases the probability of strands interacting with the structures 270, reduces the force and/or speed of the strands prior to discharge, and increases the space in which the strands can spread (and thus reduces the probability of pile formation after exiting the chute 230 and reduces the probability of collision with other strands). The dimensions of the chute 230 (including the height H₁, length L₁, inlet width W₁, outlet width W₂, and radius R₁) can generally be determined to ensure, for example, that the average velocity/force of the strands discharging from the chute 230 are at or below a threshold velocity/force. In some embodiments, the height H₁ of the chute 230 and/or curved section 236 is at least approximately 90 inches, 100 inches, 110 inches, 120 inches, 130 inches, 140 inches, or 150 inches, or within a range of approximately 90–150 inches or any increment therebetween (e.g., 127.5 inches). In some embodiments, the length L₁ of the chute 230 and/or curved section 236 is at least approximately 90 inches, 100 inches, 110 inches, 120 inches, 130 inches, 140 inches, or 150 inches, or within a range of approximately 90–150 inches or any increment therebetween (e.g., 126.5 inches).

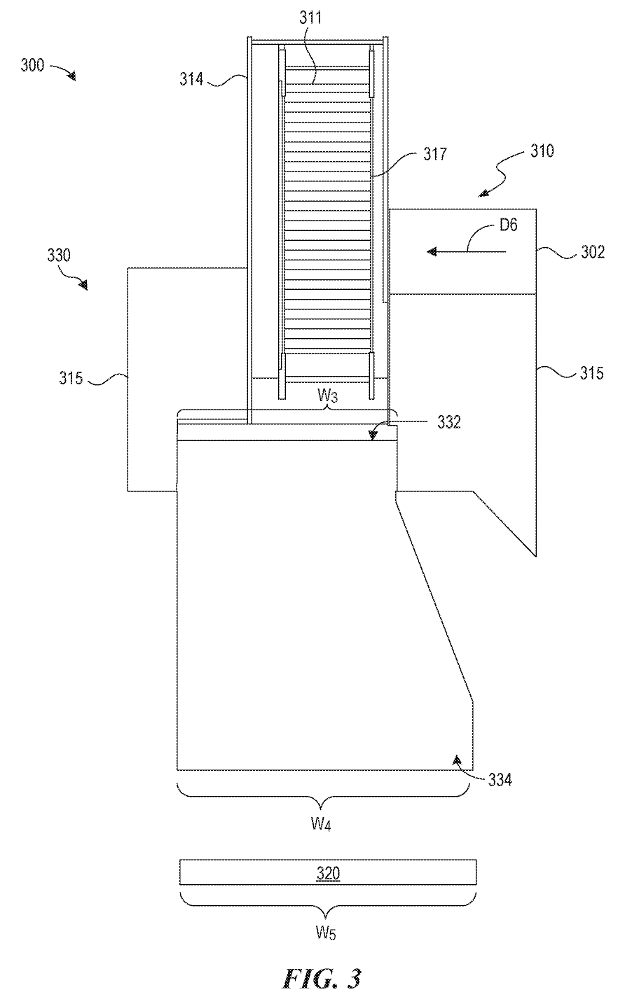

In the present embodiments, the chute 230 includes a chute outlet 234 configured to discharge strands in a discharge direction (e.g., discharge direction D3 of FIGS. 1A–1B). In some embodiments, the discharge direction is at least approximately the same as a transport direction of a conveyor (e.g., transport direction D4 of FIGS. 1A–1B). In some embodiments, the discharge direction is different from the direction the strands were received by the chute inlet 232. For example, in some embodiments, the discharge direction can be at least approximately perpendicular to the direction the strands were received. In some embodiments, the chute outlet 234 can have an outlet width W₂ that is greater than the inlet width W₁. In some embodiments, the outlet width W₂ is at least approximately the same as a width of a conveyor (e.g., width W₅ of FIG. 3) configured to receive the strands discharged from the chute outlet 234.

In some embodiments, one or more interior sections and/or surfaces of the chute 230 can be configured to include reinforcement structures 280. The reinforcement structures 280 can be configured to protect the sections and/or surfaces of the chute 230 by absorbing at least some of the impact and/or force of the strands as they enter the chute 230. The reinforcement structures 280 can also be configured to mitigate and/or prevent wear of the sections and/or surfaces of the chute 230 by providing a durable layer on the surfaces and/or sections that guide the strands as they pass through the chute 230. For example, the surface of the chute 230 opposite the strander assembly (when the chute 230 is coupled to the strander assembly) can include a reinforcement structure 280 (e.g., a first reinforcement structure), and the curved section 236 of the chute 230 can include a reinforcement structure 280 (e.g., a second reinforcement structure). In some embodiments, one or more of the reinforcement structures can include armored plates/plating that is easily replaceable (e.g., relatively easily attachable and detachable) from the interior of the chute 230 (e.g., via bolting, welding, clamping, and the like). In some embodiments, the reinforcement structures 280 are comprised of one or more of: polyurethane, metal, metal carbide, and/or metal alloy materials.

In some embodiments, the chute 230 can be provided by an original equipment manufacturer (“OEM”) to reduce the cost of implementing the system 100. The OEM chute can be retrofitted to the specifications of the system 100 or the chute 230 as described above can be retrofitted to an existing strander system. In some embodiments, the chute 230 can be manufactured to be a single replaceable piece of the system 100 and in other embodiments, the chute 230 can be separated into multiple pieces, for example, the chute inlet 132 and the chute outlet 134, to simplify the installation of replacement parts.

FIG. 3 is a partially schematic side view of a system 300, in accordance with embodiments of the present technology. In some embodiments, the system 300 includes features and/or components similar/identical to features and components of the system 100 of FIGS. 1A–1B and/or the chute 230 of FIG. 2. Moreover, all or some of the features and functionality of the chute 230 can be incorporated into the system 300 described herein.

In the present embodiments, system 300 includes a strander assembly 310, a chute 330, and a conveyor 320. The strander assembly 310 is comprised of a platform 315 configured to support a rotating disc 317. The rotating disc 317 (e.g., drum ring, disk strander) is configured to rapidly rotate one or more blades 311 to cut strands from input material 302 as the input material 302 is fed along an input path D6. One or more shielding components 314 are coupled to the platform 315 and/or rotating disc 317, and are configured to prevent strands from exiting the strander assembly 310 area in an uncontrolled manner. The shielding components 314 also help guide the strands exiting the blades 311 and/or rotating disc 317 toward a strander assembly outlet (not pictured), and into the chute 330 via a chute inlet 332.

The chute 330 is comprised of the chute inlet 332 and a chute outlet 334. The chute inlet 332 is configured to receive strands exiting the strander assembly 310. The chute outlet 334 is configured to discharge the strands from the chute 330 onto the conveyor 320. In some embodiments, a curved section (not shown) connects the chute inlet 332 to the chute outlet 334.

In some embodiments, the chute inlet 332 includes an inlet width W₃, and the chute outlet 334 includes an outlet width W₄ that is greater than the inlet width W₃. By providing a greater outlet width W₄ than inlet width W₃, strands descending/traveling through the chute 330 are able to spread and/or disperse over a greater area prior to being discharged onto the conveyor 320. This can help prevent and/or mitigate the build-up of piles of strands, separate fines (e.g., waste material) from the strands, and further reduce the speed/force of the strands as they are discharged. In some embodiments, the outlet width W₄ is approximately the same as a conveyor width W₅, allowing for an approximately even and/or uniform dispersal of the strands across the entirety of the conveyor 320.

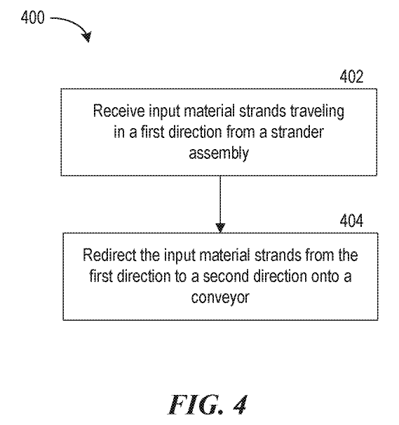

FIG. 4 is a flowchart illustrating a method 400 of guiding wood strands, in accordance with embodiments of the present technology. In some embodiments, the method 400 is implemented via one or more features and/or components of the system 100 of FIGS. 1A and 1B, chute 230 of FIG. 2, and/or system 300 of FIG. 3.

At block 402, input material (e.g., the input material 102 (FIG. 1A/1B) strands traveling in a first direction are received from a strander assembly (e.g., the strander assembly 110 of FIG. 1A/1B and/or the strander assembly 310 of FIG. 3). For example, the input material strands can include strands of wood cut from logs, lumber, or other raw forms (e.g., green wood, re-moistened wood). In some embodiments, the strands are received by the inlet of a chute (e.g., chute inlet 132 FIG. 1A/1B), where the chute (e.g., chute 130 FIG. 1A/1B) is configured to guide strands from a strander assembly to a conveyor (e.g., conveyor 120 FIG. 1A/1B). In some embodiments, the first direction is at least approximately upward with respect to a direction of gravity. In some embodiments, the first direction is at least approximately parallel to a direction of gravity.

At block 404, the input material strands are redirected from the first direction to a second direction onto a conveyor. In some embodiments, the strands are discharged from the chute via a chute outlet (e.g., chute outlet 134 FIG. 1A/1B) configured to discharge the strands in the second direction. In some embodiments, the second direction is approximately perpendicular to the first direction. In some embodiments, the second direction is approximately the same as a transport direction of the conveyor. In some embodiments, the second direction is at least approximately perpendicular to a direction of gravity.

In some embodiments, the chute inlet has a first width and the chute outlet has a second width, and the method 400 further comprises spreading the strands from the first width to the second width. In some embodiments, the method 400 further comprises spreading the strands to a width that is approximately the same as a width of the conveyor.

In some embodiments, the method 400 further comprises moving a chute relative to the conveyor as the strands are redirected from the first direction to the second direction. In some embodiments, the chute moves in a direction approximately the same as a transport direction of the conveyor. In some embodiments, the method 400 further comprises maintaining an approximately constant stand-off distance between the chute and the conveyor while the conveyor moves. In some embodiments, the method 400 further comprises maintaining a distance from the conveyor that is at least greater than a stand-off distance from the conveyor as the chute moves.

In some embodiments, the method 400 further comprises dispersing, via one or more internal structures in a chute, the strands throughout at least a portion of the chute. In some embodiments, the one or more internal structures include grooves, ridges, baffles, diverters, deflectors, bumpers, bumps, and/or the like.

In some embodiments, the method 400 further comprises absorbing, via one or more reinforcement structures, at least a portion of an impact force from the strands traveling in the first direction.

In some embodiments, the method 400 further comprises controlling, via a controller (e.g., controller 140 FIG. 1A/1B), one or more of cut speed of the strander assembly, movement of the strander assembly, movement of a chute, and/or speed of the conveyor.

In some embodiments, the method 400 further comprises slowing the strands from first velocity to a second velocity as the strands are redirected from the first direction to the second direction. The first velocity is generally dependent on the diameter of a rotating disk (e.g., rotating disk 117 FIG. 1A/1B), the revolutions per minute of the rotating disk, and/or the desired strand geometry (e.g., cross-sectional area and/or shape, length). In some embodiments, the first velocity is not less than 40 meters per second.

### Conclusion

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative embodiments may employ differing values or ranges.

The teachings of the technology provided herein can be applied to other systems, not necessarily the system described above. The elements and acts of the various examples described above can be combined to provide further embodiments of the technology. Some alternative embodiments of the technology may include not only additional elements to those embodiments noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

Certain aspects of the technology are presented below in certain claim forms, but the applicant contemplates the various aspects of the technology in any number of claim forms.

The present technology is illustrated, for example, according to various aspects described below as numbered clauses or embodiments (1, 2, 3, etc.) for convenience. These are provided as examples and do not limit the present technology. It is noted that any of the dependent clauses can be combined in any combination, and placed into a respective independent clause.
1. An apparatus of guiding wood strands from a strander assembly, the apparatus comprising: a strander assembly including a strander inlet configured to receive wood strands from logs and a strander outlet; a chute coupled to the strander outlet of the strander assembly such that the chute redirects wood strands from the strander assembly, the chute including: a chute inlet coupled to the strander outlet such that the chute receives the wood strands discharged from the strander outlet in a first direction; a chute outlet configured to discharge the wood strands in a second direction different from the first direction; and a curved section connecting the chute inlet to the chute outlet; and a conveyor positioned at the outlet of the chute and configured to transport the wood strands away from the chute, wherein the chute inlet has a first angle relative to the conveyor and the chute outlet has a second angle relative to the conveyor that is different from the first angle.
2. The apparatus of any of the clauses herein, wherein the first angle is at least approximately perpendicular to the conveyor, and wherein the second angle is at least approximately parallel to the conveyor.
3. The apparatus of any of the clauses herein, wherein the first angle is between approximately 110–80 degrees relative to the conveyor, and wherein the second angle is between approximately 0–10 degrees relative to the conveyor.
4. The apparatus of any of the clauses herein, wherein the chute inlet has a first width and the chute outlet has a second width, wherein the second width is greater than the first width.
5. The apparatus of any of the clauses herein, wherein the chute outlet has a width that is approximately the same as a width of the conveyor.
6. The apparatus of any of the clauses herein, wherein the chute is moveable relative to the conveyor.
7. The apparatus of any of the clauses herein, wherein the conveyor is configured to transport wood strands in a transport direction, and wherein the chute is configured to discharge wood strands in the same direction as the transport direction of the conveyor.
8. The apparatus of any of the clauses herein, wherein the conveyor is inclined at an angle relative to a direction of gravity.
9. The apparatus of any of the clauses herein, wherein the chute is moveable relative to the conveyor and wherein the chute is configured to maintain an approximately constant stand-off distance from the conveyor as the chute moves.
10. The apparatus of any of the clauses herein, wherein the chute is moveable relative to the conveyor and wherein the chute is configured to maintain a distance from the conveyor that is at least greater than a stand-off distance from the conveyor as the chute moves.
11. The apparatus of any of the clauses herein, further comprising a jet pump configured to apply a force to wood strands in the chute.
12. The apparatus of any of the clauses herein, wherein the chute includes one or more structures configured to disperse wood strands throughout a portion of the chute.
13. The apparatus of any of the clauses herein, wherein the chute includes one or more structures configured to disperse wood strands throughout a portion of the chute, and wherein the structures include one or more of: grooves, ridges, baffles, diverters, deflectors, bumpers, and/or bumps.
14. The apparatus of any of the clauses herein, wherein the chute includes one or more reinforcement structures configured to absorb at least a portion of an impact force from wood strands entering the chute.
15. The apparatus of any of the clauses herein, wherein the chute includes one or more reinforcement structures configured to absorb at least a portion of an impact force from wood strands entering the chute, and wherein the reinforcement structures are configured to detachably couple to an interior surface of the chute.
16. The apparatus of any of the clauses herein, wherein the apparatus includes a controller configured to control one or more parameters of the strander assembly, one or more parameters of the conveyor, and one or more parameters of the chute.
17. The apparatus of any of the clauses herein, wherein the apparatus includes a controller configured to control one or more parameters of the strander assembly, one or more parameters of the conveyor, and one or more parameters of the chute, and wherein the controller controls one or more of: cut speed of the strander assembly, movement of the strander assembly, movement of the chute, and/or speed of the conveyor.
18. The apparatus of any of the clauses herein, wherein the chute is configured to receive the wood strands at a first velocity and to slow the wood strands to a second velocity as the wood strands travel from the chute inlet to the chute outlet.
19. The apparatus of any of the clauses herein, wherein the chute is configured to receive the wood strands at a first velocity and to slow the wood strands to a second velocity as the wood strands travel from the chute inlet to the chute outlet, and wherein the first velocity is not less than 40 meters per second.
20. A chute configured to guide wood strands from a strander assembly, the chute comprising: a chute inlet configured to be coupled to and receive wood strands from a strander assembly, such that the chute inlet directs the wood strands in a first direction; a chute outlet configured to discharge the wood strands in a second direction different from the first direction; and a curved section extending between the chute inlet and the first outlet, such that the curved section guides the wood strands from the chute inlet to the chute outlet.
21. The chute of any of the clauses herein, wherein the first direction is at least approximately upward with respect to a direction of gravity, and wherein the second direction is at least approximately perpendicular to the first direction.
22. The chute of any of the clauses herein, wherein the first direction is at least approximately parallel to a direction of gravity, and wherein the second direction at least approximately perpendicular to the direction of gravity.
23. The chute of any of the clauses herein, wherein the chute inlet has a first width and the chute outlet has a second width, wherein the second width is greater than the first width.
24. The chute of any of the clauses herein, wherein the chute outlet has a width that is approximately the same as a width of a conveyor configured to receive wood strands from the chute.
25. The chute of any of the clauses herein, wherein the chute is configured to move in a third direction.
26. The chute of any of the clauses herein, wherein the chute is configured to move in a third direction, and wherein the third direction is approximately the same as the second direction.
27. The chute of any of the clauses herein, wherein the chute is configured to discharge wood strands in the second direction, and wherein the second direction is at least approximately the same as a transport direction of a conveyor configured to receive wood strands from the chute.
28. The chute of any of the clauses herein, wherein the chute is configured to move in a third direction, and wherein the chute is configured to maintain an approximately constant stand-off distance from a conveyor configured to receive wood strands from the chute as the chute moves in the third direction.
29. The chute of any of the clauses herein, wherein the chute is configured to move in a third direction, and wherein the chute is configured to maintain a distance from a conveyor configured to receive wood strands from the chute, and wherein the distance is at least greater than a stand-off distance from the conveyor as the chute moves in the third direction.
30. The chute of any of the clauses herein, wherein the chute includes one or more structures configured to disperse wood strands throughout a portion of the chute.
31. The chute of any of the clauses herein, wherein the chute includes one or more structures configured to disperse wood strands throughout a portion of the chute, and wherein the structures include one or more of: grooves, ridges, baffles, diverters, deflectors, bumpers, and/or bumps.
32. The chute of any of the clauses herein, wherein the chute includes one or more reinforcement structures configured to absorb at least a portion of an impact force from wood strands entering the chute.
33. The chute of any of the clauses herein, wherein the chute includes one or more reinforcement structures configured to absorb at least a portion of an impact force from wood strands entering the chute, and wherein the reinforcement structures are configured to detachably couple to an interior surface of the chute.
34. The chute of any of the clauses herein, wherein the curved section extends along an entirety of the length from the chute inlet to the chute outlet.
35. A method of guiding wood strands from a strander assembly to a conveyor, the method comprising: receiving, at a chute inlet of a chute, wood strands traveling in a first direction; after receiving the wood strands, guiding the wood strands via a curved intermediate region of the chute to alter a pathway of the wood strands from the first direction to a second direction different from the first direction; and discharging, at a chute outlet of the chute, the wood strands at the second direction.
36. The method of any of the clauses herein, further comprising redirecting the wood strands from the first direction to the second direction, wherein the first direction is at least approximately upward with respect to a direction of gravity, and wherein the second direction is at least approximately perpendicular to the first direction.
37. The method of any of the clauses herein, further comprising redirecting the wood strands from the first direction to the second direction, wherein the first direction is at least approximately parallel to a direction of gravity, and wherein the second direction at least approximately perpendicular to the direction of gravity.
38. The method of any of the clauses herein, wherein the chute inlet has a first width and the chute outlet has a second width, and wherein the method further comprises spreading the wood strands from the first width to the second width.
39. The method of any of the clauses herein, further comprising spreading the wood strands to a width that is approximately the same as a width of a conveyor configured to receive the wood strands from the chute outlet.
40. The method of any of the clauses herein, further comprising moving the chute relative to a conveyor configured to receive the wood strands from the chute outlet.
41. The method of any of the clauses herein, further comprising moving the chute relative to a conveyor configured to receive the wood strands from the chute outlet, wherein the chute moves in a direction approximately the same as a transport direction of the conveyor.
42. The method of any of the clauses herein, wherein discharging the wood strands includes discharging in a direction that is at least approximately the same as a transport direction of a conveyor configured to receive the wood strands from the chute outlet.
43. The method of any of the clauses herein, wherein the chute is configured to move in a direction relative to a conveyor configured to receive the wood strands from the chute outlet, and wherein the method further comprises maintaining an approximately constant stand-off distance from the conveyor as the chute moves.
44. The method of any of the clauses herein, wherein the chute is configured to move in a direction relative to a conveyor configured to receive the wood strands from the chute outlet, and wherein the method further comprises maintaining a distance from the conveyor that is at least greater than a stand-off distance from the conveyor as the chute moves.
45. The method of any of the clauses herein, further comprising dispersing, via one or more internal structures in the chute, the wood strands throughout a portion of the chute.
46. The method of any of the clauses herein, further comprising dispersing, via one or more internal structures in the chute, the wood strands throughout a portion of the chute, wherein the internal structures include one or more of: grooves, ridges, baffles, diverters, deflectors, bumpers, and/or bumps.
47. The method of any of the clauses herein, wherein the chute includes one or more reinforcement structures, and wherein the method further includes absorbing at least a portion of an impact force from the wood strands entering the chute.
48. The method of any of the clauses herein, further comprising controlling, via a controller, one or more of: cut speed of the strander assembly, movement of the strander assembly, movement of the chute, and/or speed of a conveyor configured to receive the wood strands from the chute.
49. The method of any of the clauses herein, further comprising slowing the wood strands from a first velocity to a second velocity as the wood strands travel from the chute inlet to the chute outlet.
50. The method of any of the clauses herein, further comprising slowing the wood strands from a first velocity to a second velocity as the wood strands travel from the chute inlet to the chute outlet, wherein the first velocity is not less than 40 meters per second.

We claim:

1. An apparatus of guiding wood strands from a strander assembly, the apparatus comprising:
the strander assembly, including:
a strander inlet configured to receive the wood strands, and
a strander outlet;
a chute coupled to the strander outlet of the strander assembly such that the chute redirects the wood strands from the strander assembly, the chute including:
a chute inlet coupled to the strander outlet such that the chute receives the wood strands discharged from the strander outlet in a first direction,
a chute outlet configured to discharge the wood strands in a second direction different from the first direction, and
a curved section connecting the chute inlet to the chute outlet; and
a conveyor positioned at the chute outlet and configured to transport the wood strands away from the chute,
wherein the chute inlet has a first angle relative to the conveyor, and the chute outlet has a second angle relative to the conveyor that is different from the first angle.

2. The apparatus of claim 1 wherein the first angle is approximately perpendicular to the conveyor, and wherein the second angle is approximately parallel to the conveyor.

3. The apparatus of claim 1 wherein the first angle is between approximately 120–70 degrees relative to the conveyor, and wherein the second angle is between approximately 0–20 degrees relative to the conveyor.

4. The apparatus of claim 1 wherein the chute inlet has a first width and the chute outlet has a second width, and wherein the second width is greater than the first width.

5. The apparatus of claim 1 wherein the conveyor is inclined at an angle relative to a horizontal plane.

6. The apparatus of claim 1 wherein the chute is moveable relative to the conveyor and wherein the chute is configured to maintain an approximately constant stand-off distance from the conveyor as the chute moves.

7. The apparatus of claim 1, further comprising a pump configured to apply a force in the second direction to the wood strands in the chute.

8. The apparatus of claim 1 wherein the chute includes one or more structures configured to disperse the wood strands throughout a portion of the chute and including grooves, ridges, baffles, diverters, deflectors, bumpers, and/or bumps.

9. The apparatus of claim 1, further comprising a support platform fixedly coupled to the chute to inhibit movement of the chute.

10. The apparatus of claim 1 wherein the strander assembly includes shielding components configured to direct the wood strands out of the strander outlet.

11. The apparatus of claim 1 wherein the strander assembly includes a rotating disc coupled to a blade, wherein movement of the rotating disc causes the blade to cut the wood strands.

12. The apparatus of claim 1, further comprising a controller configured to control operations of the apparatus.

13. The apparatus of claim 1 wherein the chute further comprises:
a first upper surface,
a second upper surface, and
a third upper surface, wherein the first, second, or third upper surface is configured to couple the chute inlet to the strander assembly, the chute to a shielding component, and/or the chute to a rotating disc of the strander assembly.

14. A chute configured to guide wood strands from a strander assembly, the chute comprising:
a chute inlet configured to be coupled to and receive the wood strands from a strander assembly, such that the chute inlet directs the wood strands in a first direction;
a chute outlet configured to discharge the wood strands in a second direction different from the first direction; and
a curved section extending between the chute inlet and the chute outlet, such that the curved section guides the wood strands from the chute inlet to the chute outlet.

15. The chute of claim 14 wherein the chute includes one or more reinforcement structures disposed over the curved section and configured to absorb at least a portion of an impact force from the wood strands entering the chute.

16. The chute of claim 14 wherein the chute is configured to move in a third direction different than the first direction and/or the second direction, and wherein the chute is configured to maintain an approximately constant stand-off distance from a conveyor configured to receive the wood strands from the chute as the chute moves in the third direction.

17. A method of guiding wood strands from a strander assembly to a conveyor, the method comprising:
receiving, at a chute inlet of a chute, the wood strands traveling in a first direction;
after receiving the wood strands, guiding the wood strands via a curved intermediate region of the chute to alter a pathway of the wood strands from the first direction to a second direction different from the first direction; and
discharging, at a chute outlet of the chute, the wood strands in the second direction.

18. The method of claim 17 wherein the first direction is approximately opposite a direction of gravity, and wherein the second direction is approximately perpendicular to the first direction.

19. The method of claim 17, further comprising spreading the wood strands to a width that is approximately equal to a width of the conveyor, wherein the conveyor is configured to receive the wood strands from the chute outlet.

20. The method of claim 17, further comprising moving the chute relative to the conveyor, wherein the chute moves in a direction approximately parallel to a transport direction of the conveyor, and wherein the conveyor is configured to receive the wood strands from the chute outlet.

21. The method of claim 17, further comprising controlling, via a controller, a cut speed of the strander assembly, movement of the strander assembly, movement of the chute, and/or a speed of the conveyor.

22. The method of claim 17, further comprising slowing the wood strands from a first velocity to a second velocity as the wood strands travel from the chute inlet to the chute outlet.

23. The method of claim 17, further comprising receiving logs at the strander assembly, wherein the strander assembly:
cuts the logs into the wood strands via blades mounted on a rotating disc, and
directs the wood strands to the chute inlet.

24. The method of claim 17, further comprising directing the wood strands along an input path to a cutting area that includes a blade configured to cut the wood strands to a particular width, length, thickness, and/or size.

25. The method of claim 17 wherein the wood strands are received at the chute inlet from the strander assembly, and wherein a path between the strander assembly and the chute inlet is unobstructed.
